(19) United States
(12) Patent Application Publication
(10) Pub. No.: US 2026/0351018 A1
(43) Pub. Date: Nov. 5, 2026

(54) PARAMETER CONTROL APPARATUS, METHOD, AND DEVICE CONTROL APPARATUS

(71) Applicant: NEC Corporation, Minato-ku, Tokyo (JP)

(72) Inventors: Kazuki INAGAKI, Tokyo (JP); Yuta SHIMIZU, Tokyo (JP)

(73) Assignee: NEC Corporation, Minato-ku, Tokyo (JP)

(21) Appl. No.: 19/120,299

(22) PCT Filed: Oct. 31, 2022
(86) PCT No.: PCT/JP2022/040726

§ 371 Date: Apr. 11, 2025

(51) Int. Cl. G06V 20/59; B60R 16/023; G06V 20/64

(52) U.S. Cl. CPC G06V 20/59; B60R 16/023; G06V 20/64

(57) ABSTRACT

An object detection means detects an object carried by an occupant in a vehicle. A state information acquisition means acquires state information of the vehicle. A parameter setting means sets a parameter for object detection performed by the object detection means based on the acquired state information. A device control means controls one or more controlled devices based on an object detected by the object detection means.

### TECHNICAL FIELD

The present disclosure relates to a parameter control apparatus, an object detection apparatus, a device control apparatus, a method, and a computer-readable medium.

### BACKGROUND ART

As a related technique, Patent Literature 1 discloses a vehicle load management apparatus. The vehicle load management apparatus described in Patent Literature 1 detects the approach of an occupant when the occupant approaches the vehicle with a remote key. When the approach of an occupant is detected, the vehicle load management apparatus detects baggage carried by the occupant and acquires the type of the baggage. In Patent Literature 1, the vehicle load management apparatus can acquire the type of baggage by performing image recognition on a camera image. The vehicle load management apparatus determines a baggage loading place when an occupant carries baggage and gets on the vehicle. The vehicle load management apparatus unlocks and opens the door near a place where baggage is loaded.

### CITATION LIST

### Patent Literature

Patent Literature 1: Japanese Unexamined Patent Application Publication No. 2007-001724

### SUMMARY OF INVENTION

### Technical Field

In Patent Literature 1, detection of baggage is performed regardless of the state of the vehicle. Therefore, in Patent Literature 1, in a case where baggage is identified by image processing, the object detection capability is constant. In this case, if there is a high possibility that an occupant is carrying specific baggage in a specific vehicle state, there may be a case where the specific baggage cannot be detected.

In view of the above circumstances, an object of the present disclosure is to provide a parameter control apparatus, an object detection apparatus, a device control apparatus, a method, and a computer-readable medium capable of performing object detection according to a vehicle state.

### Solution to Problem

In order to achieve the above object, a first aspect of the present disclosure provides a parameter control apparatus. A parameter control apparatus includes a state information acquisition means for acquiring state information of a vehicle, and a parameter setting means for setting a parameter for object detection performed to detect an object carried by an occupant in the vehicle based on the acquired state information.

A second aspect of the present disclosure provides an object detection apparatus. The object detection apparatus includes an object detection means for detecting an object carried by an occupant in the vehicle based on sensor information obtained from a sensor that senses the surroundings of the vehicle, and the parameter control apparatus. The parameter setting means of the parameter control apparatus sets a parameter for object detection performed by the object detection means.

A third aspect of the present disclosure provides a device control apparatus. The device control apparatus includes the object detection apparatus, and a device control means for controlling one or more controlled devices based on an object detected by the object detection apparatus.

A fourth aspect of the present disclosure provides a parameter control method. The parameter control method includes acquiring state information of a vehicle, and setting a parameter for object detection performed to detect an object carried by an occupant in the vehicle based on the acquired state information.

A fifth aspect of the present disclosure provides an object detection method. The object detection method includes: acquiring state information of a vehicle; setting a parameter for object detection performed to detect an object carried by an occupant in the vehicle based on the acquired state information; and detecting an object carried by an occupant in the vehicle based on sensor information obtained from a sensor that senses surroundings of the vehicle using the set parameter.

A sixth aspect of the present disclosure provides a device control method. The device control method includes: acquiring state information of a vehicle; setting a parameter for object detection performed to detect an object carried by an occupant in the vehicle based on the acquired state information; detecting an object carried by an occupant in the vehicle based on sensor information obtained from a sensor that senses surroundings of the vehicle using the set parameter; and controlling one or more controlled devices based on the detected object.

A seventh aspect of the present disclosure provides a computer-readable medium. The computer-readable medium stores a program for causing a processor to execute processing including acquiring state information of a vehicle, and setting a parameter for object detection performed to detect an object carried by an occupant in the vehicle based on the acquired state information.

An eighth aspect of the present disclosure provides a computer-readable medium. The computer-readable medium stores a program for causing a processor to execute processing including: acquiring state information of a vehicle; setting a parameter for object detection performed to detect an object carried by an occupant in the vehicle based on the acquired state information; and detecting an object carried by an occupant in the vehicle based on sensor information obtained from a sensor that senses surroundings of the vehicle using the set parameter.

A ninth aspect of the present disclosure provides a computer-readable medium. The computer-readable medium stores a program for causing a processor to execute processing including: acquiring state information of a vehicle; setting a parameter for object detection performed to detect an object carried by an occupant in the vehicle based on the acquired state information; detecting an object carried by an occupant in the vehicle based on sensor information obtained from a sensor that senses surroundings of the vehicle using the set parameter; and controlling one or more controlled devices based on the detected object.

### Advantageous Effects of Invention

The parameter control apparatus, the object detection apparatus, the device control apparatus, the method, and the computer-readable medium according to the present disclosure can perform object detection according to a vehicle state.

### BRIEF DESCRIPTION OF DRAWINGS

FIG. 1 is a schematic block diagram illustrating a device control apparatus according to the present disclosure.

FIG. 2 is a block diagram illustrating a device control apparatus according to an example embodiment of the present disclosure.

FIG. 3 is a diagram illustrating an example of a table stored in a device control unit.

FIG. 4 is a flowchart illustrating an operation procedure of the device control apparatus.

FIG. 5 is a block diagram illustrating an example of a hardware configuration of the device control apparatus.

### Example Embodiment

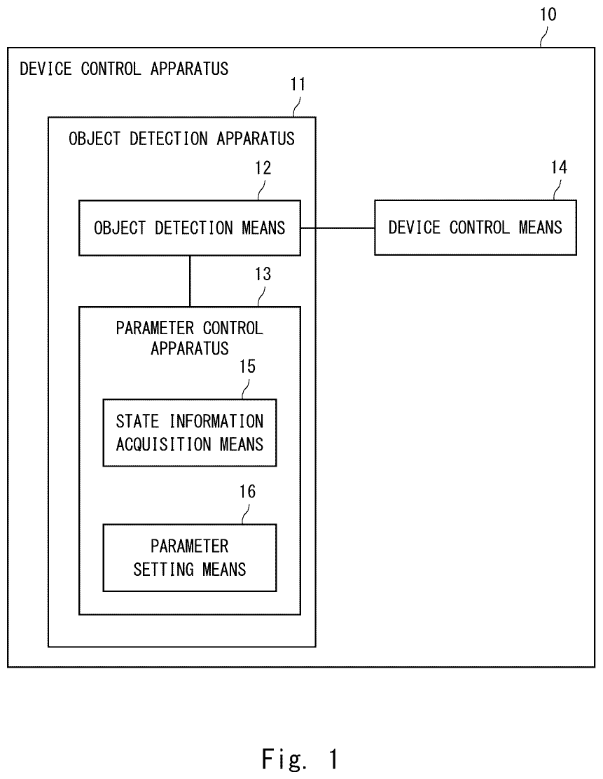

Prior to describing example embodiments of the present disclosure, an overview of the present disclosure will be given. FIG. 1 schematically illustrates a device control apparatus according to the present disclosure. A device control apparatus 10 includes an object detection apparatus 11 and a device control means 14. The object detection apparatus 11 is an apparatus that detects an object carried by an occupant in the vehicle. The object detection apparatus 11 includes an object detection means 12 and a parameter control apparatus 13. The parameter control apparatus 13 is an apparatus that controls a parameter for object detection in the object detection apparatus 11. The parameter control apparatus 13 includes a state information acquisition means 15 and a parameter setting means 16.

The object detection means 12 detects an object carried by an occupant in the vehicle on the basis of sensor information obtained from a sensor that senses the surroundings of the vehicle. The state information acquisition means 15 acquires vehicle state information. The parameter setting means 16 sets a parameter for object detection performed by the object detection means 12 on the basis of the acquired state information. The device control means 14 controls one or more controlled devices on the basis of the object detected by the object detection apparatus 11.

In the present disclosure, the parameter control apparatus 13 sets a parameter for object detection in the object detection means 12 on the basis of the acquired vehicle state information. In the present disclosure, the object detection means 12 can perform object detection with a parameter corresponding to a vehicle state. In addition, the device control apparatus 10 can control a controlled device according to the object detected by the object detection performed with the parameter according to the vehicle state.

Hereinafter, an example embodiment of the present disclosure will be described in detail with reference to the drawings. Note that in the following description and drawings, omission and simplification are made as appropriate for clarity of description. Further, in each of the drawings, the same elements and similar elements are denoted by the same reference signs, and redundant description is omitted as necessary.

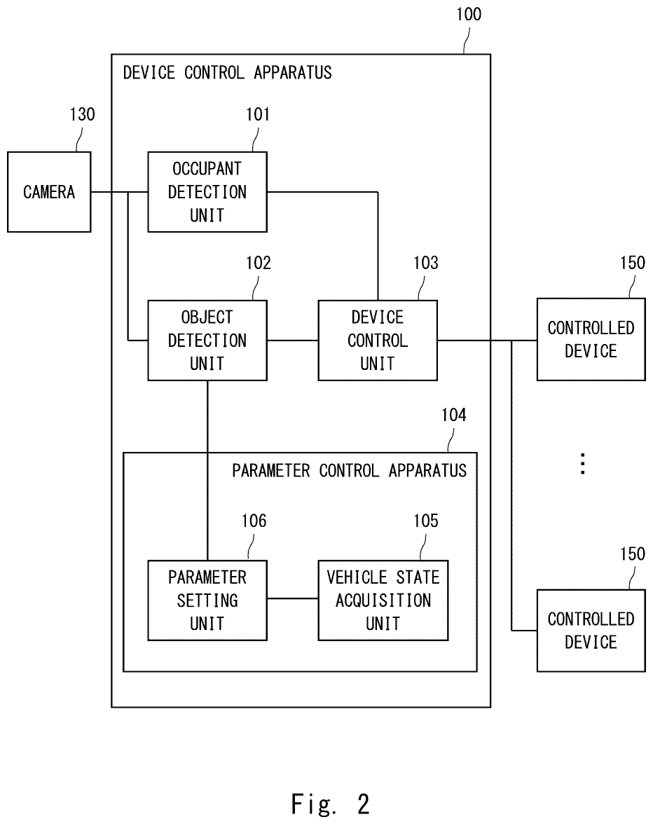

FIG. 2 illustrates a device control apparatus according to an example embodiment of the present disclosure. A device control apparatus 100 includes an occupant detection unit 101, an object detection unit 102, a device control unit 103, and a device control unit 103. The device control apparatus 100 can be physically configured as, for example, an apparatus including one or more memories and one or more processors. At least some of functions of the units in the device control apparatus 100 may be implemented by one or more processors operating according to a command read from one or more memories. The device control apparatus 100 is mounted on a vehicle, for example. The device control apparatus 100 corresponds to the device control apparatus 10 illustrated in FIG. 1.

The occupant detection unit 101 and the object detection unit 102 acquire a camera image from a camera 130. The camera 130 is a sensor that senses the surroundings of the vehicle. The camera 130 is, for example, a camera that is mounted on a vehicle and captures an image of a region around the vehicle. The camera 130 captures an image of a region outside the vehicle from the inside of the vehicle, for example. The camera 130 captures an image of a person who is about to get on the vehicle, that is, an occupant.

Note that although only one camera 130 is illustrated in FIG. 2, the number of cameras 130 is not limited to one. The occupant detection unit 101 and the object detection unit 102 may acquire a camera image from each of a plurality of cameras 130. For example, the occupant detection unit 101 and the object detection unit 102 may acquire a camera image from a camera that captures an image of a front region of the vehicle, a camera that captures an image of a left region of the vehicle, a camera that captures an image of a right region of the vehicle, and a camera that captures an image of a rear region of the vehicle.

The occupant detection unit 101 detects a person who is about to get on the vehicle, that is, an occupant, from a camera image. For example, the occupant detection unit 101 may identify a person near the vehicle, that is, an occupant, using face authentication from the camera image. For example, the occupant detection unit 101 detects a face region of a person near the vehicle from the camera image. The occupant detection unit 101 performs face authentication by comparing features extracted from the detected face region with features of a face region of a person registered in advance as an occupant. For example, the occupant detection unit 101 may identify a person approaching the driver's seat of the vehicle as the driver. Instead of or in addition to detecting an occupant from a camera image, the occupant detection unit 101 may detect an occupant by receiving radio waves from an electronic device such as a smart key carried by the occupant. The occupant detection unit 101 may also be referred to as an occupant detection means.

The object detection unit 102 detects an object from a camera image. The object detection unit 102 detects, for example, the type and size of an object carried by an occupant in the vehicle. The object detection unit 102 includes, for example, a trained artificial intelligence (AI) model for object detection. For example, in object detection, the object detection unit 102 generates a confidence score indicating object likelihood. The object detection unit 102 compares the confidence score with a threshold, and detects an object from a camera image if the confidence score is equal to or greater than the threshold. The algorithm used in the object detection unit 102 is not limited to a specific algorithm, and the object detection unit 102 may perform object detection using an arbitrary algorithm such as pattern matching. The object detection unit 102 corresponds to the object detection means 12 illustrated in FIG. 1.

A parameter control apparatus 104 controls a parameter for object detection in the object detection unit 102. The parameter control apparatus 104 includes a vehicle state acquisition unit 105 and a parameter setting unit 106. The parameter control apparatus 104 corresponds to the parameter control apparatus 13 illustrated in FIG. 1. The object detection unit 102 and the parameter control apparatus 104 constitute an apparatus corresponding to the object detection apparatus 11 illustrated in FIG. 1.

The vehicle state acquisition unit 105 acquires vehicle state information. The vehicle state acquisition unit 105 acquires, for example, position information of the vehicle and an operation status or an operation history of a device in the vehicle as vehicle state information. The vehicle state acquisition unit 105 can acquire position information of the vehicle using, for example, a global navigation satellite system (GNSS). Furthermore, the vehicle state acquisition unit 105 can acquire an operation status or an operation history of a device in the vehicle from an electronic control unit (ECU) mounted on the vehicle through an in-vehicle network such as a controller area network (CAN). For example, the vehicle state acquisition unit 105 may acquire wiper operation history information as vehicle information. Alternatively, the vehicle state acquisition unit 105 may acquire, as vehicle information, information indicating whether or not wipers were operating in the time immediately before the vehicle came to a stop.

The parameter setting unit 106 controls a parameter of the object detection unit 102 on the basis of the vehicle state information acquired by the vehicle state acquisition unit 105. For example, the parameter of the object detection unit 102 controlled by the parameter setting unit 106 includes a threshold of a confidence score in object detection. For example, the parameter setting unit 106 changes the threshold of the confidence score in object detection according to vehicle state information. The parameter of the object detection unit 102 controlled by the parameter setting unit 106 is not limited to a threshold of the confidence score. The controlled parameter may include a threshold used in determining a correspondence relationship between an object and a person who carries the object, specifically, a threshold of a degree of overlap between the person and the object, or a threshold of a distance between the person and the object.

Here, there is a case where an object carried by the occupant can be predicted to some extent on the basis of vehicle state information. For example, in a case where the vehicle is stopped at a supermarket or a shopping center, it is considered that the occupant shops and then returns to the vehicle with baggage. In addition, in a case where there is a history that a specific device, such as wipers, was moving before the vehicle stopped, it is considered that the occupant is highly likely to carry an umbrella. For example, the parameter setting unit 106 stores a correspondence relationship between a vehicle state and an object that is considered to be relatively highly likely to be detected in the vehicle state. The parameter setting unit 106 changes a parameter for object detection to a parameter different from the normal parameter for an object corresponding to vehicle state information acquired by vehicle state acquisition unit 105.

For example, in a case where the acquired vehicle state information indicates specific position information related to a supermarket or a shopping center, the parameter setting unit 106 sets the threshold of the confidence score of an object that is highly likely to be carried by the occupant, such as a shopping bag, to be low. In addition, in a case where the acquired vehicle state information indicates, for example, that wipers were operating before the stop, the threshold of the confidence score in object detection of an umbrella is lowered. For example, in a case where the threshold of the confidence score in object detection of a certain object is lowered, the object detection unit 102 can increase the probability that the object is detected. In a case where specific vehicle state information is acquired, the parameter setting unit 106 may increase the threshold of the confidence score in object detection of a specific object, and make it difficult for the object detection unit 102 to detect the specific object. In this case, erroneous detection can be suppressed.

The device control unit 103 controls one or more controlled devices 150 on the basis of detection results of the occupant detection unit 101 and the object detection unit 102. The controlled device 150 is a device that can be operated in the vehicle by an occupant in the vehicle. The controlled device 150 may include, for example, a device provided in the vehicle or a device operated by an occupant when the vehicle is driven. The controlled device 150 may include an in-vehicle device such as a display audio (DA) and a car navigation apparatus. Furthermore, the controlled device 150 may be a user device such as a smartphone carried into the vehicle by an occupant.

For example, in a case where an occupant is detected by the occupant detection unit 101, the device control unit 103 controls one or more controlled devices 150 according to the object detected by the object detection unit 102. The device control unit 103 stores, for example, a table in which an object is associated with control contents of one or more controlled devices 150. In a case where an occupant is detected, the device control unit 103 refers to the table and controls one or more controlled devices 150 with control contents corresponding to the object detected by the object detection unit 102. In the present example embodiment, it is assumed that the occupant detection unit 101 and the object detection unit 102 detect an occupant and an object when the vehicle is stopped. The occupant detection unit 101 and the object detection unit 102 perform occupant detection and object detection, for example, when the vehicle is stopped, the doors are locked, and no one is in the vehicle. The device control unit 103 controls the controlled device 150 when the occupant gets on the vehicle.

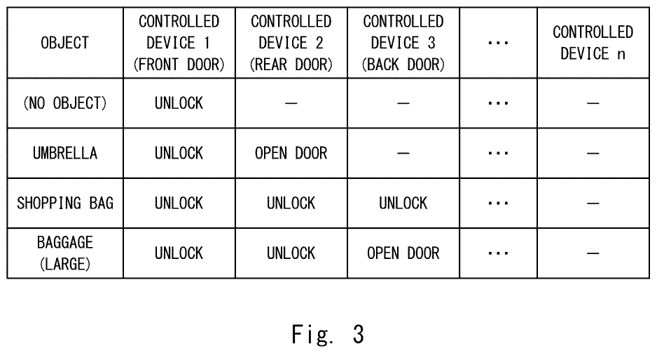

FIG. 3 illustrates an example of a table stored in the device control unit 103. In the table, a correspondence relationship between an object and control contents of one or more controlled devices 150 is registered for a plurality of objects. In the example illustrated in FIG. 3, for each of “umbrella”, “shopping bag”, and “baggage (large)”, control contents of controlled devices 1 to n are registered in the table with n being an integer of two or more. In the table, control contents of the controlled devices 1 ton in a case where there is no object to be detected may be registered. In the example illustrated in FIG. 3, the controlled device 1 is a front door, the controlled device 2 is a rear door, and the controlled device 3 is a rear door such as a trunk lid or a hatchback. The control contents of the controlled devices 1 to 3 include “unlock” and “open door”. The control contents include not controlling the controlled device 150, in other words, not instructing anything to the controlled device 150.

The table used by the device control unit 103 is not limited to the table in which a correspondence relationship between an object and control contents of one or more controlled devices 150 is registered. In the table used by the device control unit 103, control contents of one or more controlled devices 150 may be registered for a combination of identification information of an occupant and an object. In that case, the device control unit 103 may acquire control contents corresponding to a combination of identification information of an occupant detected by the occupant detection unit 101 and an object detected by the object detection unit 102 from the table, and control one or more controlled devices 150 with the acquired control contents.

In a case where the controlled device 150 is a device provided in the vehicle or a device mounted on the vehicle, the device control unit 103 may transmit a control signal to the controlled device 150 through an in-vehicle network such as CAN to control the controlled device 150. In a case where the controlled device 150 is a user device such as a smartphone, an application that communicates with the device control apparatus 100 may be installed in the user device. The device control unit 103 may transmit a control signal to the application of the user device to control an operation of the user device.

For example, in a case where the control content acquired for the front door is “unlock”, the device control unit 103 unlocks the front door. For example, in a case where the control content acquired for the rear door is “open door”, the device control unit 103 unlocks the rear door and opens the rear door. For example, in a case where the door is an electric sliding door, the device control unit 103 transmits a control signal to a controller such as an ECU that controls the electric sliding door, and controls a motor that drives the electric sliding door. For example, in a case where the door is a hinge door, the device control unit 103 may leave the door ajar using some kind of mechanism. The device control unit 103 opens and closes doors and the trunk using the result of object detection, whereby the convenience of the occupant can be improved. The device control unit 103 corresponds to the device control means 14 illustrated in FIG. 1.

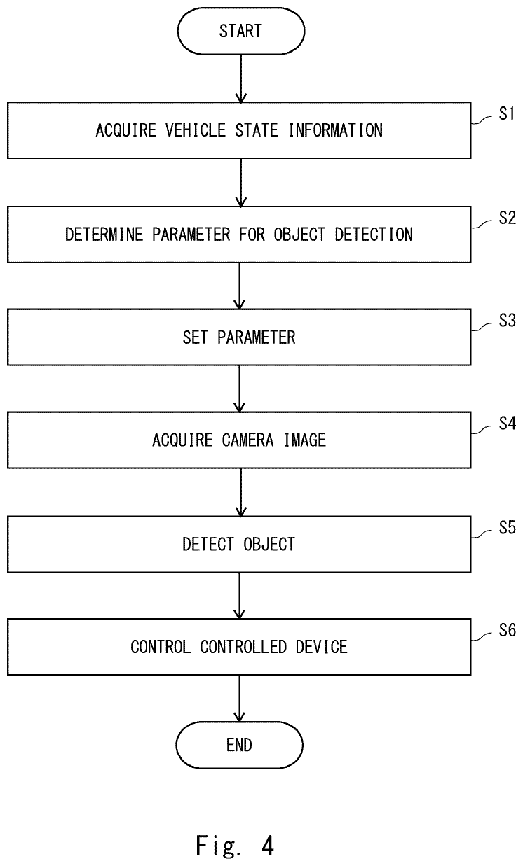

Next, an operation procedure will be described. FIG. 4 illustrates an operation procedure of the device control apparatus 100. The operation procedure of the device control apparatus 100 corresponds to a device control method. The device control method includes an object detection method performed by an object detection apparatus. The object detection method includes a parameter control method performed by the parameter control apparatus 104.

The vehicle state acquisition unit 105 of the parameter control apparatus 104 acquires vehicle state information (step S1). The parameter setting unit 106 determines a parameter for object detection to be performed by the object detection unit 102 on the basis of the vehicle state information acquired in step S1 (step S2). The parameter setting unit 106 sets the parameter determined in step S2 in the object detection unit 102 (step S3). Steps S1 to S3 correspond to the parameter control method.

The occupant detection unit 101 and the object detection unit 102 acquire camera images from the camera 130 (step S4). The occupant detection unit 101 detects an occupant from the acquired camera image. Furthermore, the object detection unit 102 detects an object carried by the occupant from the acquired camera image (step S5). In step S5, the object detection unit 102 performs object detection using the parameter set in step S3. If no object is detected, the object detection unit 102 repeatedly performs the acquisition of the camera image in step S3 and the object detection in step S4. The detection of an occupant and the detection of an object may be simultaneously performed in the same processing unit. Steps S1 to S5 correspond to the object detection method.

The device control unit 103 controls one or more controlled devices 150 on the basis of the detection result of the occupant in the occupant detection unit 101 and the object detected in the object detection unit 102 (step S6). In step S6, the device control unit 103 controls one or more controlled devices 150 with control contents corresponding to the object detected in step S5, for example. For example, if an umbrella is detected in step S5, the device control unit 103 controls one or more controlled devices 150 with the control content for a case where an umbrella is detected.

In the present example embodiment, the parameter control apparatus 104 acquires a vehicle state, and sets a parameter for object detection in the object detection unit 102 on the basis of the acquired vehicle state. An object carried by an occupant may change according to the state of the vehicle. For example, when it is considered, from the vehicle state information, that the occupant highly probably carries a certain object, the parameter control apparatus 104 changes the parameter of an AI engine that detects the object in the object detection unit 102. For example, in a case where the parameter is changed to lower the threshold of the confidence score in object detection, the object detection unit 102 easily detects an object that is highly likely to be carried by the occupant. In the present example embodiment, the parameter control apparatus can appropriately set the parameter for object detection according to the vehicle state. Furthermore, the object detection unit 102 can perform object detection using a parameter set according to the vehicle state. Moreover, the device control apparatus 100 can control the controlled device 150 by using a result of object detection performed using a parameter set according to the vehicle state.

Note that the above example embodiment describes an example in which the occupant detection unit 101 and the object detection unit 102 detect an occupant and an object from a camera image. However, the present disclosure is not limited thereto. The occupant detection unit 101 and the object detection unit 102 may perform occupant detection and object detection, respectively, using sensor information acquired from a sensor different from the camera 130. The sensor information used by the occupant detection unit 101 and the sensor information used by the object detection unit 102 are not necessarily the same sensor information.

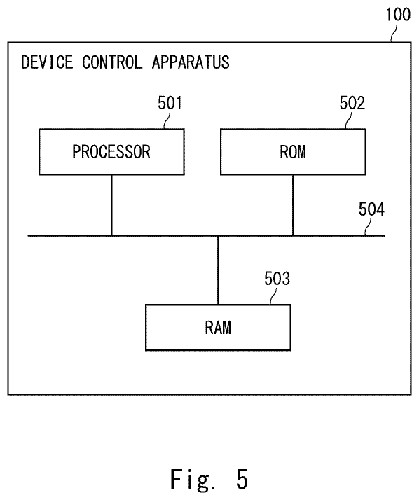

Next, a hardware configuration of the device control apparatus 100 will be described. FIG. 5 illustrates an example of a hardware configuration of the device control apparatus 100. The device control apparatus 100 includes a processor (central processing unit (CPU)) 501, a read only memory (ROM) 502, and a random access memory (RAM) 503. In the device control apparatus 100, the processor 501, ROM 502, and RAM 503 are interconnected via a bus 504. The device control apparatus 100 may include another circuit such as a peripheral circuit, a communication circuit, and an interface circuit, although illustration thereof is omitted.

The ROM 502 is a non-volatile storage device. For example, a semiconductor storage device such as a flash memory having a relatively small capacity is used for the ROM 502. The ROM 502 stores a program executed by

The program described above includes a group of commands (or software codes) for causing a computer to perform one or more functions described in the example embodiment when the program is read by the computer. The program may be stored in a non-transitory computer-readable medium or a tangible storage medium. As an example and not by way of limitation, the computer-readable medium or the tangible storage medium includes a RAM, a ROM, a flash memory, a solid-state drive (SSD) or any other memory technology, a compact disc (CD), a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, the transitory computer-readable medium or the communication medium includes electrical, optical, acoustic, or other forms of propagated signals.

The RAM 503 is a volatile storage device. As the RAM 503, various types of semiconductor memory devices such as a dynamic random access memory (DRAM) or a static random access memory (SRAM) can be used. The RAM 503 can be used as an internal buffer for transitorily storing data and the like.

The processor 501 loads the program stored in the ROM 502 on the RAM 503, and executes the program. The function of each unit in the device control apparatus 100 can be implemented by the CPU 501 executing the program.

Note that the device control apparatus 100 is not necessarily a single apparatus. The device control apparatus 100 may be configured using a plurality of physically separated apparatuses. For example, the device control apparatus 100 may be separated into an apparatus including the occupant detection unit 101, an apparatus including the object detection unit 102 and the parameter control apparatus 104, and an apparatus including the device control unit 103. Alternatively, the device control apparatus 100 may be separated into an apparatus including the occupant detection unit 101 and the object detection unit 102, an apparatus including the device control unit 103, and an apparatus including the parameter control apparatus 104. Further, in the parameter control apparatus 104, the vehicle state acquisition unit 105 and the parameter setting unit 106 may be configured as a plurality of physically separated apparatuses.

The device control apparatus 100 only needs to be able to control the controlled device 150 in the vehicle, and does not necessarily have all the functions mounted on the vehicle. For example, in the device control apparatus 100, the occupant detection unit 101, the object detection unit 102, and the parameter control apparatus 104 may be disposed outside the vehicle. In that case, the occupant detection unit 101 and the object detection unit 102 may receive a camera image from the camera 130 via a wireless communication network. In addition, the device control unit 103 may receive the occupant detection result and the object detection result from the occupant detection unit 101 and the object detection unit 102 via the wireless communication network. The parameter control apparatus 104 may transmit a parameter for object detection to the object detection unit 102 via a network.

Although an example embodiment according to the present disclosure has been described above in detail, the present disclosure is not limited to the above-described example embodiment, and the present disclosure also includes those that are obtained by making changes or modifications to the above-described example embodiment without departing from the spirit of the present disclosure.

For example, a portion or the entirety of the above-described example embodiment can be described as, but not limited to, the following Supplementary Notes.

### Supplementary Note 1

A parameter control apparatus including:
a state information acquisition means for acquiring state information of a vehicle; and
a parameter setting means for setting a parameter for object detection performed to detect an object carried by an occupant in the vehicle based on the acquired state information.

### Supplementary Note 2

The parameter control apparatus according to Supplementary Note 1, in which the parameter includes a threshold for a score indicating object likelihood in the object detection.

### Supplementary Note 3

The parameter control apparatus according to Supplementary Note 2, in which the parameter setting means changes the threshold based on the acquired state information.

### Supplementary Note 4

The parameter control apparatus according to any one of Supplementary Notes 1 to 3, in which
the state information includes position information of the vehicle, and the parameter setting means sets the parameter according to the position information.

### Supplementary Note 5

The parameter control apparatus according to any one of Supplementary Notes 1 to 4, in which
the state information includes operation history information of a device in the vehicle, and
the parameter setting means sets the parameter according to the operation history information.

### Supplementary Note 6

The parameter control apparatus according to Supplementary Note 5, in which
an object detected in the object detection is an umbrella, and
the operation history information includes operation history information of a wiper in the vehicle.

### Supplementary Note 7

An object detection apparatus including:
an object detection means for detecting an object carried by an occupant in a vehicle based on sensor information obtained from a sensor that senses surroundings of the vehicle, and
the parameter control apparatus according to any one of Supplementary Notes 1 to 6,
in which the parameter setting means sets a parameter for object detection performed by the object detection means.

### Supplementary Note 8

The object detection apparatus according to Supplementary Note 7, in which
the sensor is a camera that captures an image of a region around the vehicle, and
the sensor information is a camera image acquired using the camera.

### Supplementary Note 9

A device control apparatus including:
the object detection apparatus according to Supplementary Note 7 or 8; and
a device control means for controlling one or more controlled devices based on an object detected by the object detection apparatus.

### Supplementary Note 10

The device control apparatus according to Supplementary Note 9, further including an occupant detection means for detecting an occupant in the vehicle,
in which the device control means controls the one or more controlled devices based on a detection result of the occupant by the occupant detection means and an object detected by the object detection apparatus.

### Supplementary Note 11

A parameter control method including:
acquiring state information of a vehicle; and
setting a parameter for object detection performed to detect an object carried by an occupant in the vehicle based on the acquired state information.

### Supplementary Note 12

An object detection method including:
acquiring state information of a vehicle;
setting a parameter for object detection performed to detect an object carried by an occupant in the vehicle based on the acquired state information; and
detecting an object carried by an occupant in the vehicle based on sensor information obtained from a sensor that senses surroundings of the vehicle using the set parameter.

### Supplementary Note 13

A device control method including:
acquiring state information of a vehicle;
setting a parameter for object detection performed to detect an object carried by an occupant in the vehicle based on the acquired state information;
detecting an object carried by an occupant in the vehicle based on sensor information obtained from a sensor that senses surroundings of the vehicle using the set parameter; and
controlling one or more controlled devices based on the detected object.

### Supplementary Note 14

A non-transitory computer-readable medium storing a program for causing a processor to execute processing including:
acquiring state information of a vehicle; and
setting a parameter for object detection performed to detect an object carried by an occupant in the vehicle based on the acquired state information.

### Supplementary Note 15

A non-transitory computer-readable medium storing a program for causing a processor to execute processing including:
acquiring state information of a vehicle;
setting a parameter for object detection performed to detect an object carried by an occupant in the vehicle based on the acquired state information; and
detecting an object carried by an occupant in the vehicle based on sensor information obtained from a sensor that senses surroundings of the vehicle using the set parameter.

### Supplementary Note 16

A non-transitory computer-readable medium storing a program for causing a processor to execute processing including:
acquiring state information of a vehicle;
setting a parameter for object detection performed to detect an object carried by an occupant in the vehicle based on the acquired state information;
detecting an object carried by an occupant in the vehicle based on sensor information obtained from a sensor that senses surroundings of the vehicle using the set parameter; and
controlling one or more controlled devices based on the detected object.

### REFERENCE SIGNS LIST

10 DEVICE CONTROL APPARATUS
11 OBJECT DETECTION APPARATUS
12 OBJECT DETECTION MEANS
13 PARAMETER CONTROL APPARATUS
14 DEVICE CONTROL MEANS
15 STATE INFORMATION ACQUISITION MEANS
16 PARAMETER SETTING MEANS
100 DEVICE CONTROL APPARATUS
101 OCCUPANT DETECTION UNIT
102 OBJECT DETECTION UNIT
103 DEVICE CONTROL UNIT
104 PARAMETER CONTROL APPARATUS
105 VEHICLE STATE ACQUISITION UNIT
106 PARAMETER SETTING UNIT
130 CAMERA
150 CONTROLLED DEVICE
501 PROCESSOR
502 ROM
503 RAM
504 BUS

What is claimed is:

1. A parameter control apparatus comprising:
at least one memory storing instructions; and
at least one processor configured to execute the instructions to:
acquire state information of a vehicle; and
set a parameter for object detection performed to detect an object carried by an occupant in the vehicle based on the acquired state information.

2. The parameter control apparatus according to claim 1, wherein the parameter includes a threshold for a score indicating object likelihood in the object detection.

3. The parameter control apparatus according to claim 2, wherein the at least one processor is configured to execute the instructions to change the threshold based on the acquired state information.

4. The parameter control apparatus according to claim 1, wherein
the state information includes position information of the vehicle, and
the at least one processor is configured to execute the instructions to set the parameter according to the position information.

5. The parameter control apparatus according to claim 1, wherein
the state information includes operation history information of a device in the vehicle, and
the at least one processor is configured to execute the instructions to set the parameter according to the operation history information.

6. The parameter control apparatus according to claim 5, wherein
an object detected in the object detection is an umbrella, and
the operation history information includes operation history information of a wiper in the vehicle.

7-8. (canceled)

9. A device control apparatus comprising:
at least one memory storing instructions; and
at least one processor configured to execute the instructions to:
perform object detection to detect an object carried by an occupant in a vehicle based on sensor information obtained from a sensor that senses surroundings of the vehicle;
acquire state information of the vehicle;
set a parameter for the object detection based on the acquired state information;
control one or more controlled devices based on the detected object.

10. The device control apparatus according to claim 9, wherein the at least one processor is configured to execute the instructions to:
detect an occupant in the vehicle; and
control one or more controlled devices based on a detection result of the occupant and the detected object.

11. A parameter control method comprising:
acquiring state information of a vehicle; and
setting a parameter for object detection performed to detect an object carried by an occupant in the vehicle based on the acquired state information.

12-16. (canceled)
